(19) United States
(12) Patent Application Publication
(10) Pub. No.: US 2012/0021786 A1
(43) Pub. Date: Jan. 26, 2012

(54) METHOD OF SENDING A MESSAGE USING A MOBILE PHONE

(76) Inventors: Hui-Man Hou, Beijing (CN); Jian Ming Jin, Beijing (CN); Yuhong Xiong, Mountain View, CA (US)

(21) Appl. No.: 13/259,436

(22) PCT Filed: Oct. 9, 2009
(86) PCT No.: PCT/CN09/74364

§ 371 Date: Sep. 23, 2011

(51) Int. Cl. H04W 4/18; H04W 88/02

(52) U.S. Cl. 455/466; 455/556.1

(57) ABSTRACT

Presented is a method and system for sending a message using a mobile phone. The method includes composing a message for sending to a recipient, generating a contact-label having contact information of the recipient, combining the message and the contact-label, capturing an image of the message and the contact-label combination for sending to the recipient using the mobile phone, decoding the captured image for identifying the contact information of the recipient, and sending the message to identified contact information.

### BACKGROUND

Usage of mobile devices for communication has increasingly become popular. If email revolutionized the way people communicated earlier, short messaging service (or SMS) on mobile phones is no far behind. It has become an order of the day among people, especially youth, to connect with each other using simple text or multimedia based messaging service. However, despite its wide-spread use, composing and sending of a short or multimedia message on a mobile phone is still a difficult and cumbersome task, especially for some people, such as the elderly.

Further, it is hard to compose a long text message or a message mixing text with other media (such as, an image, a video, etc) on a mobile phone. Another approach for sending a long or multimedia message is to first write the message on a piece of paper. In usual course, a person captures the image of a paper using the camera integrated in the mobile phone, saves the captured image in the phone, and sends it as a multimedia message to a contact or a set of contacts. This approach requires the person to use a multimedia message sending software to send the image, which means that the person has to dial the phone number of the recipient, or use the address book in the phone. If the phone number is not in the address book, the person has to enter it carefully and check it in order not to send it to a wrong person. In brief, the process is cumbersome, as it requires the person to interact with both an image capture interface, a multimedia message composing and sending interface and sometimes a contact address book interface. Needless to say, the methods outlined above for sending a message greatly impacts the battery life of the device.

### BRIEF DESCRIPTION OF THE DRAWINGS

For a better understanding of the invention, embodiments will now be described, purely by way of example, with reference to the accompanying drawings, in which:

FIG. 1 shows a flow chart of a method of sending a message using a mobile phone according to an embodiment.

FIG. 2 shows a system for sending a message using a mobile phone according to an embodiment.

### DETAILED DESCRIPTION OF THE INVENTION

Considering, for many people, writing on paper is still the most natural and preferred way of communicating with one another, the following embodiment describes a method and a mobile system which enables people to send captured image, especially the image of a handwritten message, as multimedia message with a printed contact-label that embeds the mobile phone number of the recipient.

For clarity and convenience, following definition is used herein:

The term “contact-label” refers to an image with embedded contact information (such as name, email address, phone number, mobile number, homepage URL) of a person, a group or an organization.

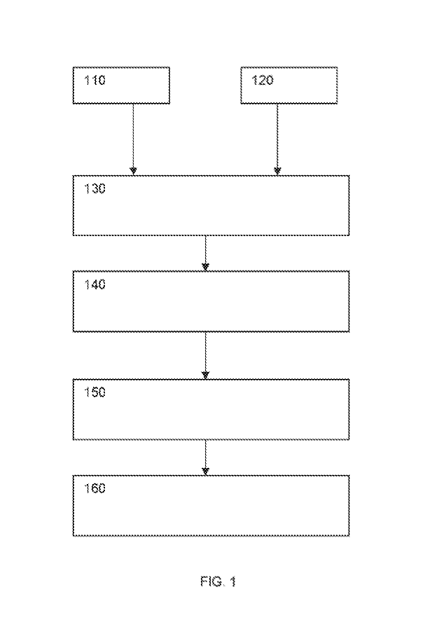

FIG. 1 shows a method of sending a message using a mobile phone according to an embodiment.

Step 110 includes composing a message for sending to a recipient. In an embodiment, a sender may simply write a message on a piece of paper or any stationery, for sending to a recipient. In another embodiment, a sender may write on specially printed contact-paper printed with a recipient's contact label. In a still another embodiment, a message may just be an image.

Step 120 includes generating a contact-label having contact information of a recipient.

As mentioned earlier, a contact-label is an image with embedded contact information (such as name, email address, phone number, mobile number, homepage URL) of a person, a group or an organization.

Various approaches may be used to generate a contact-label in accordance with different embodiments. One approach (generating approach) includes generating an image which encodes the contact information, especially the mobile number. In this approach, the contact information encoding component encodes contact information to certain encoded data format. Then, the contact information encoding component generates an image that codes the contact information. The generated image may be a barcode image or a matrix code image. For example, QR code is a widely used 2D matrix code. It has three squares in the edge of the coded image for the decoder to determine the area and angle of code matrix. It has a high capacity which can encode more than 4000 alpha-numeric characters, or more than 1800 Chinese characters. The code also contains data correction information generated by correction polynomial to make the code resistant to damage or dirt contamination

Another approach (embedding approach) includes embedding contact information within an existing image. Firstly, a user registers an image with a mobile number or a set of mobile numbers through the contact information configuration component. The image can be a personal photo of the contact, a handwritten signature, some text, a geometric figure, or any related or unrelated picture. Secondly, the contact information encoding component encodes contact information to certain data format. Thirdly, the contact information embedding component embeds encoded data into the original registered image by information hiding technique such as watermarking.

The image embedded with contact information is the image of a contact-label.

After a contact-label has been generated, it may be printed out for use in message sending. A contact-label printing component prints the contact-label on paper or adhesive paper, such as stickers. The paper printed with contact-label is called contact-label paper. In an embodiment, a printer connecting component connects a mobile phone with a printer. There are various approaches to connect the mobile phone with a printer. One approach is to connect the mobile phone with a printer directly via Bluetooth or WIFI. Another approach is to connect the mobile phone with a computer which can access the printer. In the latter approach, the contact-label image is copied to a computer and then printed.

Step 130 includes combining a message with a contact-label. In an embodiment, a sender may simply place or paste a contact label(s) of a recipient(s) onto surface of the message (for example, paper) carrying the sender's message. In another embodiment, if a sender wants to send an image of an apparatus, the contact label(s) of a recipient(s) may be placed or pasted onto the surface of the apparatus.

Step 140 includes capturing an image of the message and the contact-label combination for sending to the recipient using the mobile phone. In an embodiment, a photography taking component of a mobile phone (integrated with a camera) may be used to capture the image of the message and the contact-label combine for sending to the recipient.

Step 150 includes decoding the captured image for identifying the contact information of the recipient. In an embodiment, a contact-label detection component detects all contact-labels from the captured image. The contact-label decoding component decodes the embedded contact information from each contact-label and obtains the mobile number of each contact.

Step 160 includes sending the message to identified contact information. A message sending component sends the captured image via a multimedia message service to all decoded mobile phone numbers.

In an embodiment, a contact list updating component saves the contact information decoded from a contact-label to the mobile phone's contact list for further use. In another embodiment, if a contact-label is captured or received from others as a multimedia message, the embedded contact information is decoded to update the contact information stored in the mobile.

The following examples illustrate the use of different embodiments.

### EXAMPLE 1

### Sending Message Written on Contact-Paper as Multimedia Message

Tom wants to send a message to Alice. Tom just writes on the contact-paper printed with Alice's contact-label. To send the message as multimedia message, Tom photographs the whole contact-paper with mobile integrated camera. An embodiment can detect the contact-label and decode embedded contact information in the label, and send out the captured image as a multimedia message to Alice's mobile phone number.

### EXAMPLE 2

### Sending Message Written on Normal Paper as Multimedia Message

Alice wants to send a message to Tom. She just writes on a piece of normal paper, and pastes a printed contact-label representing Tom's contact information on the normal paper. Then Alice photographs the paper with mobile integrated camera. An embodiment can detect the contact-label and decode the embedded recipient's information in the label, and send out the captured image as a multimedia message to Tom.

### EXAMPLE 3

### Grandmother Sends Message to her Grandson

A grandmother wants to send a message to her grandson, but she forgets her grandson's mobile phone number and doesn't know how to find contact information from the contact address book. Her grandson can solve the problem by printing out a stack of contact-labels with his mobile phone number embedded as well as some other information in advance and give them to his grandmother. The image of the contact-label can be his personal photo for easy identification. Hence, the grandmother can just write message on a piece of normal paper, paste her grandson's contact-label (her grandson's photo) on the paper, and take picture of the paper with the mobile integrated camera. Then, an embodiment can detect the contact-label and decode it to get the grandson's mobile phone number. After that, the system sends the captured image as multimedia message to the grandson's mobile phone number automatically. If the grandson's mobile phone number changes, he just needs to print a new stack of contact-labels and give to his grandmother.

### EXAMPLE 4

### Grandson Sends Contact-Label to Grandmother as a Multimedia Message

In example 3, the grandson can actually send the image of his contact-label to grandmother as a multimedia message. The received contact-label image will be printed out from grandmother's printer as contact-label or contact-paper. Therefore, the grandmother can use the contact-label or contact-paper to write message to her grandson.

### EXAMPLE 5

### Jimmy Sends the Picture of His New Laptop to Jane

Besides message writing on paper, the mobile integrated camera can take pictures of everything. For example, Jimmy wants to send his new laptop's picture to Jane via multimedia message, he sticks a contact-label of Jane on the surface of the laptop and photographs the laptop, then the embodiment detects the contact-label and decodes it, so the multimedia message of the laptop's picture is sent to Jane automatically. If the contact-label is not pasted properly, the embodiment will inform the user and the user can choose to dial the number himself or recapture the image.

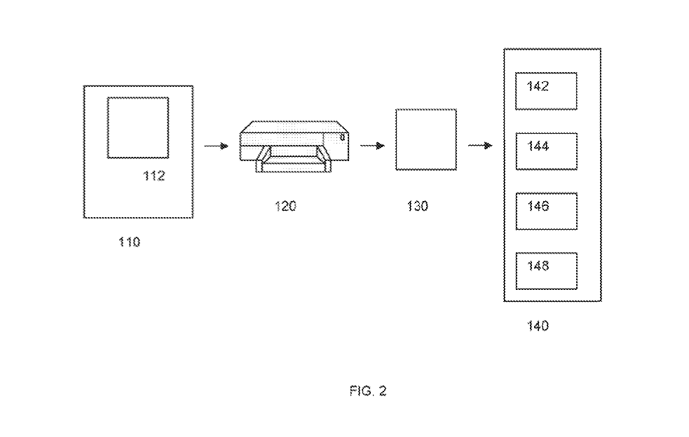

FIG. 2 shows a system for sending a message using a mobile phone according to an embodiment.

The system 100 according to an embodiment comprises a data processing unit 110, a printing unit 120, an image capture unit 130 for capturing an image of a document comprising a contact-label and a mobile communication device 140 for decoding the captured image to identify a mobile phone number and sending the captured image to the identified mobile phone number.

The data processing unit 110 includes a contact-label generation unit 112 for creating a contact label. The examples of a data processing unit 110 include a computer desktop, a laptop, a mobile communication device, etc. The data processing unit typically includes a processor and a memory (not shown). The processor is coupled to the memory and configured to process instructions, stored in the memory, for generating a contact-label. The memory may be internal or external to the data processing unit 110.

The printing unit 120 prints a contact label(s). The examples of a printing unit 120 include an inkjet printer, a laser printer, an AiO, a MFP, etc. In an embodiment, a printer connecting component connects the data processing unit 110 with the printing unit 120. The connection may be through wired or wireless means.

The image capture unit 130 may be a camera integrated with a mobile communication device. The image capture unit 130 is used for capturing an image of a message and a contact-label combination for sending to a recipient using a mobile communication device.

The mobile communication device 140 may include a mobile phone, a personal digital assistant (PDA), or a hand-held mobile internet communicator device. In an embodiment, a photography taking component 142 of a mobile communication device (integrated with a camera) is used to capture the image of the message and the contact-label combine for sending to the recipient. Then, a contact-label detection component 144 detects all contact-labels from the captured image. The contact-label decoding component 146 decodes the embedded contact information from each contact-label and obtains the mobile number of each contact. A message sending component 148 sends the captured image via multimedia message service to all decoded mobile phone numbers.

In an embodiment, the image capture unit 130 and mobile communication device 140 may be integrated in one device, for example in a camera phone.

It would be appreciated that the components depicted in FIG. 2 are for the purpose of illustration only and the actual components (including their number) may vary depending on the system deployed for implementation of the present invention.

It would be appreciated that the embodiments described above simplifies the process of composing and sending a message to merely writing the message on a piece of paper, pasting a contact-label and taking a picture of the paper. This enables people who are not comfortable using conventional short message or multimedia message sending software, and people whose written language cannot be easily typed on a mobile phone keyboard (like Chinese) to send out their message easily. Moreover, it makes it easy for people to compose a message that mixes text and images.

Further, since the contact-label generation or printing stage is separate from the contact-label decoding stage, no configuration changes are required on the sender's mobile phone. The embodiments provide increased privacy since other people do not know the mobile phone number of the recipient or even about the recipient by looking at the contact-label. Furthermore, sending multimedia message without dialing or choosing the recipient's phone number is useful for some people or some situations. Also, not only paper pasted or printed with contact-label, but also anything pasted with contact-label can be captured to be sent out as multimedia message automatically. This makes a multimedia message sending more fun and easier. Since messages are written on paper instead of composed on a mobile phone, mobile phone power used for composing the message is saved.

It would be further appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A method of sending a message using a mobile phone, the method comprising:
composing a message for sending to a recipient;
generating a contact-label having contact information of the recipient;
combining the message and the contact-label;
capturing an image of the message and the contact-label combination for sending to the recipient using the mobile phone;
decoding the captured image for identifying the contact information of the recipient; and
sending the message to identified contact information.

2. A method according to claim 1, wherein the message is composed on paper.

3. A method according to claim 1, wherein the step of generating a contact label, comprises:
generating an image encoded with contact information.

4. The method according to claim 1, wherein the step of generating a contact label, comprises:
generating an image embedded with contact information.

5. The method according to claim 1, wherein the contact-label comprises an image with contact information details of the recipient.

6. The method according to claim 5, wherein the contact information details includes name, email address, phone number, mobile number and/or homepage URL of the recipient.

7. The method according to claim 1, wherein the step of decoding the captured image for identifying the contact information of the recipient, comprises:
detecting a contact-label from the captured image;
decoding the contact information from the contact-label; and
identifying the contact information of the recipient.

8. A method according to claim 1, further comprising:
printing a contact-label having contact information of a recipient for combining with a message.

9. A method according to claim 8, wherein the contact label is printed as an adhesive sticker.

10. A method according to claim 1, wherein the step of combining the message and the contact-label includes placing the contact label onto surface of the message.

11. A method according to claim 1, further comprising saving the contact information decoded from a contact-label in the mobile phone for further use.

12. A system for sending a message, the system comprising:
a data processing unit for generating a contact label;
a printing unit coupled to the data processing unit for printing the contact label;
an image capture unit for capturing an image of a message and the contact-label combination; and
a mobile communication unit coupled to the image capture unit for decoding the captured image to identify contact information of a recipient and sending the message to the identified contact information.

13. A system according to claim 12, wherein the image capture unit and the mobile communication unit are integrated together in one device.

14. A computer program comprising computer program means adapted to perform all of the steps of claim 1 when said program is run on a computer.

15. A computer program according to claim 14 embodied on a computer readable medium.
